(19) United States
(12) Patent Application Publication
(10) Pub. No.: US 2014/0197988 A1
(43) Pub. Date: Jul. 17, 2014

(54) METHOD OF ESTIMATING A QUANTITY ASSOCIATED WITH A RECEIVER SYSTEM

(71) Applicant: CURTIN UNIVERSITY OF TECHNOLOGY, Bentley (AU)

(72) Inventors: Petrus Johannes Gertrudis Teunissen, Bateman (AU); Gabriele Giorgi, Starnberg (DE); Peter Jacob Buist, Delft (NL)

(73) Assignee: CURTIN UNIVERSITY OF TECHNOLOGY, Bentley (AU)

(21) Appl. No.: 14/215,418

(22) Filed: Mar. 17, 2014

Related U.S. Application Data
(63) Continuation of application No. PCT/AU2012/001077, filed on Sep. 10, 2012.

(30) Foreign Application Priority Data
Sep. 9, 2011 (AU) 2011903843

(51) Int. Cl. G01S 19/01

(52) U.S. Cl. CPC G01S 19/01
USPC 342/357.39

(57) ABSTRACT

The present disclosure provides a method of estimating a quantity associated with a receiver system. The receiver system comprises a plurality of spaced apart receivers that are arranged to receive a signal from a satellite system. The method comprises the step of receiving the signal from the satellite system by receivers of the receiver system. Further, the method comprises calculating a position estimate and an attitude estimate associated with the receiver system using the received signal. The method also comprises determining a relationship between the calculated position estimate and the calculated attitude estimate. In addition, the method comprises estimating the quantity associated with the receiver system using the determined relationship between the calculated position estimate and the calculated attitude estimate.

### CROSS REFERENCE TO RELATED APPLICATIONS

This application is a Continuation of International Application No. PCT/AU2012/001077, International Filing Date Sep. 10, 2012, and which claims the benefit of AU patent application No. 2011903843, filed Sep. 19, 2011, the disclosures of both applications being incorporated herein by reference.

### FIELD OF INVENTION

The present invention relates to a method of estimating a quantity associated with a receiver system and relates particularly, though not exclusively, to a method that uses precise point positioning for obtaining information concerning a position or an attitude of the receiver system.

### BACKGROUND OF THE INVENTION

A global navigation satellite system (GNSS) can be used for positioning using various techniques. Some techniques, such as techniques that involve relative positioning, require a stationary receiver as a reference and a roaming receiver to provide accurate position information.

Another positioning technique, referred to as precise point positioning (PPP), can be performed using a single receiver. PPP is a method of processing GNSS pseudo-range and carrier-phase observations from a GNSS receiver to compute relatively accurate positioning. PPP does not rely on the simultaneous combination of observations from other reference receivers and therefore offers greater flexibility. Further, the position of the receiver can be computed directly in a global reference frame, rather than positioning relative to one or more reference receiver positions.

The PPP convergence time is defined as the time needed to collect sufficient GNSS data so as to reach nominal accuracy performance. Unfortunately, known PPP techniques require a relatively long data acquisition times, which can be up to 20 minutes, for the position estimates to converge to accuracy levels in the centimetre range. It would be of benefit if PPP techniques could be developed that allow shorter convergence times.

Accuracy is the counterpart of convergence times and consequently faster convergence is achievable at the expense of accuracy.

Finally, integrity is defined as a system's ability to self-check for the presence of corrupted data or other errors such as cycle slips, multi path interference, atmospheric disturbances. It would be of advantage if a PPP technique could be developed that achieves higher integrity and consequently results in a more robustness and reliability.

### SUMMARY OF THE INVENTION

In accordance with a first aspect of the present invention, there is provided a method of estimating a quantity associated with a receiver system, the receiver system comprising a plurality of spaced apart receivers that are arranged to receive a signal from a satellite system, the method comprising the steps of:
receiving the signal from the satellite system by receivers of the receiver system;
calculating a position estimate associated with at least one of the receivers and an attitude estimate associated with at least two receivers;
determining a relationship between the calculated position estimate and the calculated attitude estimate; and
estimating the quantity associated with the receiver system using the determined relationship between the calculated position estimate and the calculated attitude estimate.

The quantity associated with the receiver system may for example be a position or attitude estimate of the receiver system, or may relate to atmospheric and/or ephemeris information.

Embodiments of the present invention provide significant advantages. Using the determined relationship between the position estimate and the attitude estimate, a position or attitude estimate may be provided with improved accuracy. Further, a reduced convergence time may be achieved.

The steps of calculating a position estimate and an attitude estimate, determining a relationship between the calculated position estimate and the calculated attitude estimate, and estimating the quantity may be performed immediately after receiving the signal from the satellite system such that the quantity is estimated substantially instantaneously.

The receivers of the receiver system typically have a known spatial relationship relative to each other and the step of estimating the quantity typically comprises using known information associated with the known spatial relationship.

Calculating the position estimate and the attitude estimate using the known information associated with positions of the receivers typically allows for a more accurate estimate to be obtained.

The receivers of the receiver system may be arranged in a substantially symmetrical manner and may form an array.

The method may comprise selecting positions of the receivers relative to each other in a manner such that the accuracy of the estimate of the quantity associated with the receiver system is improved compared with an estimate obtained for different relative receiver positions.

The step of determining the relationship between the position estimate and the attitude estimate may comprise determining a dispersion of the position estimate and the attitude estimate. Further, the step of estimating the quantity associated with the receiver system may comprise processing the position estimate and attitude estimate using information associated with the determined dispersion. Processing the position and attitude estimates may comprise applying a decorrelation transformation. Applying the decorrelation transformation typically comprises using information associated with each of the position estimate and the attitude estimate.

In one embodiment the receiver system comprises a first and a second group of receivers and the method comprises the steps of:
calculating a position and an attitude estimate for receivers of the first group and receivers of the second group;
determining a relationship between at least one estimates for the first group of receivers with at least one estimates for the second group of receivers; and
using the determined relationship for estimating the quantity associated with the receiver system.

The signal may be a single frequency signal. Alternatively, the signal may be a multiple frequency signal.

In accordance with a second aspect of the present invention, there is provided a tangible computer readable medium containing computer readable program code for estimating a quantity associated with a receiver system comprising a plurality of spaced apart receivers, the receivers being arranged to receive a signal from a satellite system, the tangible computer readable medium being arranged, when executed, to:
calculate a position estimate and an attitude estimate associated with the receiver system using a received signal;
determine a relationship between the calculated position estimate and the calculated attitude estimate of the receiver system; and
estimate the quantity associated with the receiver system using the determined relationship between the position estimate and the attitude estimate.

### BRIEF DESCRIPTION OF THE DRAWINGS

Embodiments of the present invention will now be described, by way of example only, with reference to the accompanying drawings in which:

FIG. 1 is a schematic diagram of a system for estimating a quantity associated with a receiver system in accordance with an embodiment of the present invention;

FIG. 2 is a flow diagram of a method of estimating a quantity associated with a receiver system in accordance with an embodiment of the present invention; and

FIG. 3 is a schematic diagram of a calculation system in accordance with the system of FIG. 1.

### DETAILED DESCRIPTION OF THE SPECIFIC EMBODIMENTS

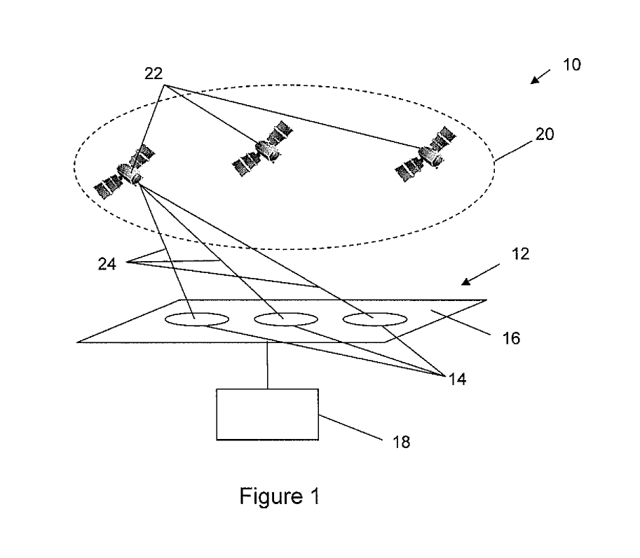

Specific Embodiments of the present invention are now described with reference to FIGS. 1 to 3 in relation to a method of, and a system for, estimating a quantity associated with a receiver system, such as estimating information concerning the position or attitude of the receiver.

FIG. 1 illustrates a system 10 for estimating a quantity associated with a receiver system. In this embodiment the system 10 is arranged for obtaining positional information. The system 10 comprises a receiver array 12 comprising a plurality of receivers 14 mounted on a platform 16 in a known configuration. The receiver array 12 is in data communication with a calculation system 18.

Each receiver 14 is arranged to receive navigational signals 24 from satellites 22 that form part of a global navigation satellite system (GNSS) 20. The receivers 14 can be any appropriate receiving device, such as a GPS receiver, and will comprise an antenna for receiving the navigational signals 24. The receivers 14 are spaced apart from each other by an appropriate distance so as to allow for accurate attitude estimates to be obtained.

Each receiver 14 may be an antenna in communication with its own associated GPS receiver. Alternatively, each receiver may be an antenna in communication with a single GPS receiver. A combination of these two receiver configurations could also be used.

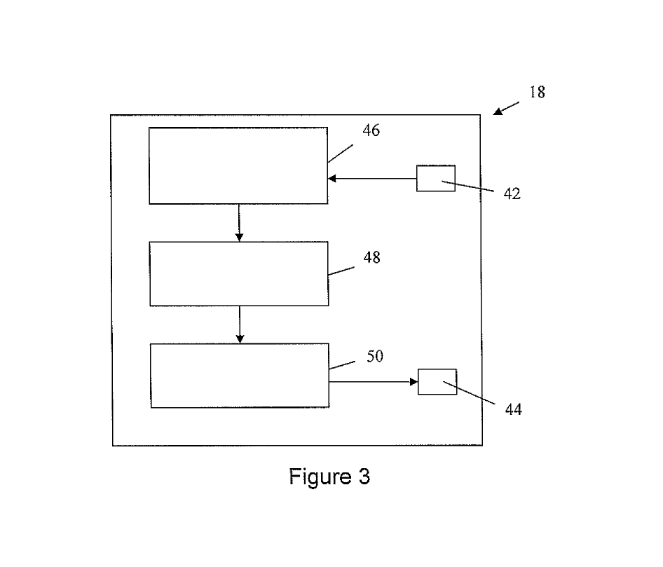

The received navigational signals 24 are then communicated to the calculation system 18 arranged to calculate position and attitude estimates associated with the receiver array 12 in accordance with a method 30 of obtaining positional information as described below. The calculation system 18 is described later in more detail with reference to FIG. 3.

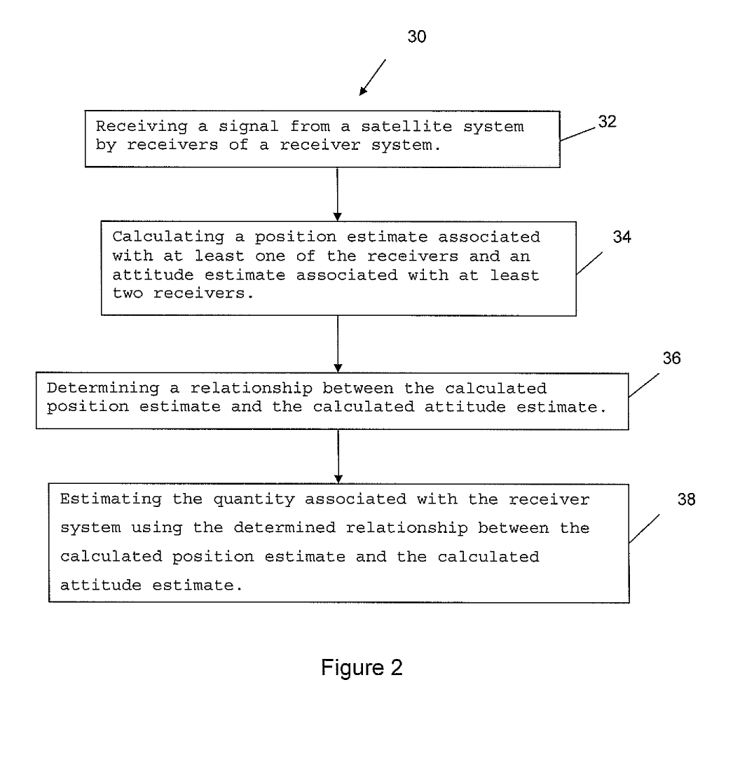

FIG. 2 illustrates the method 30 of estimating a quantity associated with a receiver system. In this example the method is used to obtain positional information. The method 30 comprises a first step 32 of receiving the navigational signals 24 from the satellites 22 by each of the plurality of receivers 14.

A second step 34 of the method 30 comprises calculating a position estimate and an attitude estimate associated with the receiver array 12 by using the received navigational signals 24. A third step 36 comprises determining a relationship between the position estimate and the attitude estimate associated with the receiver array.

A fourth step 38 of the method 30 comprises calculating an improved position estimate wherein the calculation includes using the determined relationship between the position estimate and the attitude estimate of the receiver array 12. A person skilled in the art will appreciate that alternatively for example an improved attitude estimate may be calculated.

Determining the relationship between the position estimate and the attitude estimate comprises determining the correlation between the position estimate and the attitude estimate. Knowledge of this correlation is then used to improve the position estimate.

In one embodiment, knowledge of the correlation is used to decorrelate a model used to provide the position estimate, wherein the decorrelated model can then be used to provide the improved position estimate.

The position estimate can be further improved by using information associated with the geometry of the receivers. Typically, knowing the geometry of the receivers can be used to obtain a more accurate attitude estimate. The more accurate attitude estimate can in turn be used to obtain a more accurate improved position estimate and can allow the system to obtain the estimate substantially instantaneously.

In one embodiment of the method 30, the second, third and fourth steps 32, 34, 36 involve the processing of information in the form of matrices by appropriate matrix operations. As such, and in view of the fact that this embodiment is described with reference to various matrix operations, what follows is a brief overview of some of the general concepts referred to herein.

Matrices are denoted with capital letters and vectors by lower-case letters. An m×n matrix is a matrix with m rows and n columns. A vector of dimension n is called an n-vector. (.)^{T} denotes vector or matrix transposition.

Iₙ denotes the n×n unit (or identity) matrix. c₁ is a unit vector with its 1 in the first slot, i.e c₁=[1,0, . . . , 0]^{T}, and eₛ is an s-vector of 1s, eₛ=[1, . . . , 1]^{T}. An (s−1)×s matrix having eₛ as its null space, i.e. Dₛ^{T}eₛ=0 and [Dₛ,eₛ] invertible, is called a differencing matrix. An example of such a matrix is Dₛ^{T}=[−eₛ₋₁, Iₛ₋₁]. The projector identity ΣᵣDᵣ(Dᵣ^{T}ΣᵣDᵣ)⁻¹Dᵣ^{T}=Iᵣ−eᵣ(eᵣ^{T}Σᵣ⁻¹eᵣ)⁻¹eᵣ^{T}Σᵣ⁻¹ can be used for any positive definite matrix Σᵣ.

The squared M-weighted norm of a vector x is denoted as ∥x∥_{M}²=x^{T}M⁻¹x. In case M is the identity matrix, ∥x∥²=∥x∥_{I}². E(a) and D(a) denote the expectation and dispersion of the random vector a. An n×n diagonal matrix with diagonal entries mᵢ is denoted as diag[m₁, . . . , mₙ]. A blockdiagonal matrix with diagonal blocks Mᵢ is denoted as blockdiag[M₁, . . . , Mₙ].

Let A be an m×n matrix and B be a p×q matrix. The mp×nq matrix defined by (A)ᵢⱼB is called the Kronecker product and it is written as A [symbol] B=(A)ᵢⱼB. The vec-operator transforms a matrix into a vector by stacking the columns of the matrix one underneath the other. Properties of the vec-operator and Kronecker product are: vec(ABC)=(C^{T} [symbol] A)vec(B), (A [symbol] B)(C [symbol] D)=AB [symbol] CD, (A [symbol] B)^{T}=A^{T} [symbol] B^{T}, and (A [symbol] B)⁻¹=A⁻¹ [symbol] B⁻¹ (A and B invertible matrices).

After the first step 32 of receiving a navigational signal 24, the second step 34 comprises calculating a position estimate and an attitude estimate of the receivers 24 by using the received navigational signals 34 from the one or more satellites 22.

For a receiver 14 (represented by r in the following) that tracks a satellite 22 (represented by s in the following) on frequency fⱼ=c/λⱼ at time τ, the observation equations for the carrier-phase Φ_{r,j}^{s}(τ) and pseudo-range (code) p_{r,j}^{s}(τ) read:

φ_{r,j}^{s}(τ)=lᵣ^{s}(τ)+δr_{r,j}(τ)−δs_{,j}^{s}(τ)+tᵣ^{s}(τ)−μⱼiᵣ^{s}(τ)+λⱼa_{r,j}^{s}+e_{r,j}^{s}(τ)

p_{r,j}^{s}(τ)=lᵣ^{s}(τ)+dr_{r,j}(τ)−ds_{,j}^{s}(τ)+tᵣ^{s}(τ)+μⱼiᵣ^{s}(τ)+e_{r,j}^{s}(τ) (1)

where lᵣ^{s} is the unknown range from receiver r to satellite s, δr_{r,j} and dr_{r,j} are the unknown receiver phase and code clock errors, δs_{,j}^{s} and ds_{,j}^{s} are the unknown satellite phase and code clock errors, tᵣ^{s} is the unknown tropospheric path delay, iᵣ^{s} is the unknown ionospheric path delay on frequency f₁ (μⱼ=λⱼ²/λ₁²), and a_{r,j}^{s}=φ_{r,j}(t₀)−φ_{,j}^{s}(t₀)+z_{r,j}^{s} is the unknown phase ambiguity that consists of the initial phases of receiver and satellite, φ_{r,j}(t₀) and φ_{,j}^{s}(t₀), and the integer ambiguity z_{r,j}^{s}. The phase ambiguity as a_{r,j}^{s} is assumed time-invariant as long as the receiver keeps lock. The unmodelled errors of phase and code are represented by ε_{r,j}^{s} and e_{r,j}^{s}, respectively. They will be modelled as zero mean random variables, i.e. E(ε_{r,j}^{s}(τ))=E(e_{r,j}^{s}(τ))=0, with E(.) being the mathematical expection. All the unknowns, except the ambiguity, are expressed in units of range. The ambiguity is expressed in cycles, rather than range.

The observables Φ_{r,j}^{s}(τ) and p_{r,j}^{s}(τ) of (1) are referred to as the undifferenced (UD) phase and code observables, respectively. When receiver r tracks two satellites s and t on frequency fⱼ=c/λⱼ at the same time τ, one can form the between-satellite, single-differenced (SD) phase and code observables, Φ_{r,j}^{st}(τ)=Φ_{r,j}^{t}(τ)−Φ_{r,j}^{s}(τ) and p_{r,j}^{st}(τ)=p_{r,j}^{t}(τ)−p_{r,j}^{s}(τ), respectively. Their observation equations are given as

E(φ_{r,j}^{st}(τ))=lᵣ^{st}(τ)−δs_{,j}^{st}(τ)+tᵣ^{st}(τ)−μⱼiᵣ^{st}(τ)+λⱼa_{r,j}^{st}

E(p_{r,j}^{st}(τ))=lᵣ^{st}(τ)−ds_{,j}^{st}(τ)+tᵣ^{st}(τ)+μⱼiᵣ^{st}(τ) (2)

In these SD equations, the receiver phase and the receiver code clock errors, δr_{r,j}(τ) and dr_{r,j}(τ), have been eliminated. Likewise, the initial receiver phases are absent in the SD ambiguity a_{r,j}^{st}=−φ_{,j}^{st}(t₀)+z_{r,j}^{st}. In the following, the argument of time τ is not shown explicitly, unless really needed.

To write (2) in vector-matrix form, it is assumed that receiver r tracks s satellites on f frequencies. With the jth-frequency SD observation vectors defined as y_{φ;r,j}=[φ_{r,j}¹², . . . , φ_{r,j}^{1s}]^{T} and y_{p;r,j}=[p_{r,j}¹², . . . , p_{r,j}^{1s}]^{T}, the jth-frequency vectorial equivalent of (2) is given by E(y_{φ;r,j})=lᵣ+tᵣ−δs_{,j}−μⱼiᵣ+λⱼa_{r,j} and E(y_{p;r,j})=lᵣ+tᵣ−ds_{,j}+μⱼiᵣ with lᵣ=[lᵣ¹², . . . , lᵣ^{1s}]^{T} and a likewise definition for tᵣ, δs_{,j}, δs_{,j}, iᵣ and a_{r,j}. Note that the first satellite is used as a reference (i.e. pivot) in defining the SD. This choice is not essential as any satellite can be chosen as pivot.

For f frequencies, the SD phase and code observation vectors are defined as y_{φ;r}=[y_{φ;r,1}^{T}, . . . , y_{φ;r,f}^{T}]^{T} and y_{p;r}=[y_{p;r,1}^{T}, . . . , y_{p;r,f}^{T}]^{T}. The vectorial form of the SD observation equations then reads

E(y_{φ;r})=(e_{f} [symbol] Iₛ₋₁)(lᵣ+tᵣ)−δs−(μ [symbol] Iₛ₋₁)iᵣ+(Λ [symbol] Iₛ₋₁)a,

E(y_{p;r})=(e_{f} [symbol] Iₛ₋₁)(lᵣ+tᵣ)−ds+(μ [symbol] Iₛ₋₁)iᵣ (3)

with δs=[δs_{,1}^{T}, . . . , s_{,f}^{T}]^{T} and a likewise definition for ds, μ, iᵣ and aᵣ. Λ is the diagonal matrix of wavelengths, Λ=diag(λ₁, . . . , λ_{f}). With s satellites tracked on f frequencies, the number of equations in (3) is 2f(s−1).

The system of SD equations (3) forms the basis of a point positioning model used to provide position estimates.

The following illustrates subsequent steps used to determine a position estimate of a receiver r.

The range from receiver r to satellite s, lᵣ^{s}=∥bᵣ−b^{s}∥, is a nonlinear function of the position vectors of receiver and satellite, bᵣ−b^{s}. To obtain a linear model, approximate values bᵣ^{o} and b^{os} are used to linearise the receiver-satellite range lᵣ^{s} with respect to bᵣ^{s}=bᵣ−b^{s}. This gives lᵣ^{s}≈(l^{s})^{o}+(∂_{b}l^{s})^{o}Δbᵣ^{s}=(∂_{b}lᵣ^{s})^{o}bᵣ^{s}, with lᵣ^{o}=∥bᵣ^{o}−b^{os}∥, (∂_{b}lᵣ)^{o=}(bᵣ^{o}−b^{os})^{T} [symbol] bᵣ^{o}−b^{os}∥ and Δbᵣ^{s}=bᵣ^{s}−bᵣ^{os}. The second-order remainder can be neglected for all practical purposes, since it is inversely proportional to the very large GNSS receiver-satellite range (GPS satellites are at high altitudes of about 20,000 km).

From lᵣ^{s}=(∂_{b}lᵣ^{s})^{o}bᵣ^{s} and lᵣ^{t}=(∂_{b}lᵣ^{t})^{o}bᵣ^{t}, the SD range lᵣ^{st}=lᵣ^{t}−lᵣ^{s} follow as lᵣ^{st}=gᵣ^{st}bᵣ₋oᵣ^{st}, with gᵣ^{st}=[(∂_{b}lᵣ^{t})^{o}−(∂_{b}lᵣ^{t})^{o}−(∂_{b}lᵣ^{s})^{o}] and oᵣ^{st}=[(∂_{b}lᵣ^{t})^{o}b^{t}−(∂_{b}lᵣ^{s})^{o}b^{s}]. The row-vector gᵣ^{st} contains the difference of the two unit-direction vectors from receiver to satellite and the scalar oᵣ^{st} contains the receiver relevant orbital information of the two satellites. Hence, in vector-matrix form the SD range vector lᵣ. can be expressed in the receiver position vector bᵣ as

lᵣ=Gᵣbᵣ−oᵣ (4)

with Gᵣ=[gᵣ^{12T}, . . . , gᵣ^{1sT}]^{T} and oᵣ=[oᵣ¹², . . . , oᵣ^{1s}]^{T}.

For the tropospheric delay tᵣ, one usually uses an a priori model (e.g. Saastemoinen model). In case such modelling is not considered accurate enough, one may compensate by including the residual tropospheric zenith delay tᵣ^{z} as an unknown parameter. In this case, in SD form:

tᵣ=(tᵣ)^{o}+lᵣtᵣ^{z} (5)

with (tᵣ)^{o} provided by the a priori model and lᵣ the SD vector of mapping functions (e.g. Niels functions).

If we define Kᵣ=[Gᵣ,lᵣ] and xᵣ=[bᵣ^{T},tᵣ^{z}]^{T}, (3), (4) and (5) may be combined, to give

$$E [ \begin{matrix}{y}_{φ ; r} \\ {y}_{p ; r}\end{matrix} ] = [ \begin{matrix}{e}_{f} ⊗ {K}_{r} & - μ ⊗ {I}_{s - 1} & Λ ⊗ {I}_{s - 1} \\ {e}_{f} ⊗ {K}_{r} & + μ ⊗ {I}_{s - 1} & 0\end{matrix} ] [ \begin{matrix}{x}_{r} \\ {i}_{r} \\ {a}_{r}\end{matrix} ] + [ \begin{matrix}{c}_{φ ; r} \\ {c}_{p ; r}\end{matrix} ] \qquad ( 6 )$$

with c_{φ;r-}e_{f} [symbol] ((tᵣ)^{o}−oᵣ)−δs and c_{p;r-}e_{f} [symbol] ((tᵣ)^{o}−oᵣ)−ds.

The system of SD observation equations (6) forms the basis for multi-frequency precise point positioning. Its unknown parameters are solved for in a least-squares sense, often mechanized in a recursive Kalman filter form. The unknown parameter vectors are xᵣ, iᵣ and aᵣ. The 4-vector xᵣ=[bᵣ^{T},tᵣ^{z}]^{T} contains the receiver position vector and the tropspheric zenith delay. The (s−1)-vector iᵣ contains the SD ionospheric delays and the f(s−1)-vector aᵣ contains the time-invariant SD ambiguities. The vectors c_{φ;r} and c_{p;r} are assumed known. They consist of the a priori modelled tropospheric delay and the satellite ephemerides (orbit and clocks). This information is publicly available and can be obtained from global tracking networks, like IGS or JPL (see e.g. http://www.igs.org/components/prods.html).

The following method is used to determine an attitude estimate of the platform 16. In this embodiment, the attitude estimate is based on the array 12 of r receivers all tracking the same s satellites 22 on the same f frequencies. With two receivers (r=2) one can determine the heading and pitch of the platform 16 and with three receivers (r=3) one can determine the full orientation of the platform 16 in space. Using more than three receivers adds to the robustness of the attitude estimate.

With two or more receivers 14, one can formulate the so-called double-differences (DD), which are between-receiver differences of between-satellite differences. For two receivers q and r tracking the same s satellites on the same f frequencies, the DDs are defined as y_{φ;qr}=y_{φ;r}−y_{φ;q} and y_{p;qr}=y_{p;r}−y_{p;q}. In the DDs, both the receiver clock errors and the satellite clock errors get eliminated. Moreover, since double differencing eliminates all initial phases, the DD ambiguity vector a_{qr}=aᵣ−a_{q} is an integer vector. This is an important property. It strengthens the model and it will be taken advantage of in the parameter estimation process. To emphasize the integerness of the DD ambiguity vector, z_{qr} is represented as z_{gr}=a_{qr}.

For estimating the attitude, it may be further assumed that the size of the array 12 is such that also the between-receiver differential contributions of orbital perturbations, troposphere and ionosphere are small enough to be neglected. Hence, the terms c_{φ;r,=}c_{p;r,} tᵣ and iᵣ, that are present in the between-satellite SD model (6), can be considered absent in the DD attitude model. Also, since the unit-direction vectors of two nearby receivers to the same satellite are the same for all practical purposes, K=K_{q}=Kᵣ, or G=G_{q}=Gᵣ and l=l_{q}=lᵣ. For two nearby receivers q and r, the vectorial DD observation equations follow therefore from (6) as

E(y_{φ;qr})=(c_{f} [symbol] G)b_{qr}+(Λ [symbol] Iₛ₋₁)z_{qr}

E(y_{φ;qr})=(c_{f} [symbol] G)b_{qr} (7)

in which b_{qr}=bᵣ−b_{q} is the baseline vector between the two receivers q and r.

The single-baseline model (7) is easily generalized to a multi-baseline or array model. Since the size of the array 12 is assumed small, the model can be formulated in multivariate form, thus having the same design matrix as that of the single-baseline model (7). For the multivariate formulation, receiver 1 is taken as the reference receiver (i.e. the master) and the f(s−1)−(r−1) phase and code observation matrices are defined as Y_{φ}=∂y_{φ;12}, . . . , y_{φ;1r}] and Yₚ=[y_{p;12}, . . . , y_{p;1r}], respectively, the 3×(r−1) baseline matrix is defined as B=[b₁₂, . . . , b₁ᵣ], and the f(s−1)×(r−1) integer ambiguity matrix is defined as Z=[z₁₂, . . . , z₁ᵣ]. The multivariate equivalent to the DD single-baseline model (7) follows then as:

$$E [ \begin{matrix}{Y}_{φ} \\ {Y}_{p}\end{matrix} ] = [ \begin{matrix}{e}_{f} ⊗ G & A ⊗ {I}_{s - 1} \\ {e}_{f} ⊗ G & 0\end{matrix} ] [ \begin{matrix}B \\ Z\end{matrix} ] \qquad ( 8 )$$

The unknowns in this model are the matrices B and Z. The matrix B [symbol] [symbol] ^{3×(r-1)} consists of the r−1 unknown baseline vectors and the matrix Z [symbol] [symbol] ^{2f(s-1)}×^{(r-1)} consists of the 2f(s−1)(r−1) unknown DD integer ambiguities.

In the case of attitude estimation, one often knows the receiver geometry in the local body frame. This information can be incorporated into the array model (8), thereby strengthening its ability of accurate attitude estimation. Let F be the q×(r−1) matrix that contains the known baseline coordinates in the body-frame. Then B and F are related as

B=RF (9)

in which the q column vectors of R are orthonormal, i.e. R^{T}R=I_{q} or R [symbol] [symbol] ^{3×q}. With rᵢ the ith column vector of R and fᵢⱼ the (scalar) entries of F, for two and for three receivers, respectively:

$$RF = [ {r}_{1} ] [ {f}_{11} ] \\ and \\ RF = [ {r}_{1} , {r}_{2} ] [ \begin{matrix}{f}_{11} & {f}_{21} \\ 0 & {f}_{22}\end{matrix} ] \qquad ( 10 )$$

and for more than three receivers

$$RF = [ {r}_{1} , {r}_{2} , {r}_{3} ] [ \begin{matrix}{f}_{11} & {f}_{21} & {f}_{31} & … & {f}_{( r - 1 ) 1} \\ 0 & {f}_{22} & {f}_{32} & … & {f}_{( r - 1 ) 2} \\ 0 & 0 & {f}_{33} & … & {f}_{( r - 1 ) 3}\end{matrix} ] \qquad ( 11 )$$

Thus q=1 if r=2, q=2 if r=3 and q=3 if r≧4. R is a full rotation matrix in case r>3.

For attitude estimation, (8) with (9), is solved in a least-squares sense. It is a multivariate constrained integer least-squares problem with two types of constraints: the integer constraints of the ambiguities, Z [symbol] [symbol] ^{2f(s-1)}×^{(r-1)}, and the orthonormality constraint on the attitude matrix, R [symbol] [symbol] ^{3×q}.

The following illustrates determining a relationship between the position estimates and the attitude estimates

Usually the point positioning model (6) is processed independently from the attitude determination model (8). In this embodiment, however, the two models are combined. If the following are defined: y₁=[y_{φ;1}^{T},y_{p;1}^{T}]^{T}, c₁=[c_{φ;1}^{T},c_{p;1}^{T}]^{T}, Y=[Y_{φ}^{T},Yₚ^{T}]^{T}, H=[Λ^{T},0^{T}]^{T} and h=[−μ^{T}, +μ^{T}]^{T}, the models (6) and (8) can be written in the compact form:

E(y₁)=(e_{2f} [symbol] G)b₁+(H [symbol] Iₛ₋₁)a₁+d₁

E(Y)=(e_{2f} [symbol] G)B+(H [symbol] Iₛ₋₁)Z (1 2)

where d₁=(e_{2f} [symbol] l₁)t₁^{z}+(h [symbol] Iₛ₋₁)i₁+c₁. Note that these two sets of observation equations have no parameters in common This is the reason why the two sets of equations have been treated separately.

The first set is then used to estimate the position of the array 12, i.e. to determine b₁ from y₁, while the second set is used to estimate the attitude of the array 12, i.e. to determine B (or R) from E However, despite this lack of common parameters, the data of the two sets are correlated and thus are not independent. In this section, it is described how to take advantage of this correlation. In this embodiment, the dispersion of [y₁, Y] is first determined as described below.

To determine the dispersion of the position and attitude estimates, or of the SD and the DD observables in (12), assumptions on the dispersion of the UD phase and code observables are made. For the dispersion of the UD phase and code vectors, φ_{r,j}=[φ_{r,j}¹, . . . , φ_{r,j}^{s}]^{T} and p_{r,j}=[p_{r,j}¹, . . . , p_{r,j}^{s}]^{T}, it is assumed:

D(φ_{r,j})=(Qᵣ)ᵣᵣ(Q_{f})ⱼⱼQ_{φ} and D(p_{r,j})=(Qᵣ)ᵣᵣ(Q_{f})ⱼⱼQₚ (13)

with positive scalars (Qᵣ)ᵣᵣ and (Q_{f})ⱼⱼ, and positive definite matrices Qᵣ, Q_{f}, Q_{φ} and Qₚ. The scalars permit specifying the precision contribution of receiver r and frequency f, while the s×s matrices Q_{φ} and Qₚ identify the relative precision contribution of phase and code. With the matrices Q_{φ} and Qₚ one can also model the satellite elevation dependency of the dispersion. The covariance between Φ_{r,j} and p_{r,j} is assumed zero.

For f frequencies, (13) generalizes to

D(φᵣ)=(Qᵣ)ᵣᵣQ_{f} [symbol] Q_{φ} and D(pᵣ)=(Qᵣ)ᵣᵣQ_{f} [symbol] Qₚ (14)

where Φᵣ=[Φ_{r,1}, . . . , Φ_{r,f}]^{T} and pᵣ=[p_{r,1}, . . . , p_{r,f}]^{T}, Let Dₛ^{T} be the (s−1)×s differencing matrix that transforms UD observables into between-satellite SD observables. Then the corresponding SD vectors of Φᵣ and pᵣ are y_{φ;r}=(I_{f} [symbol] Dₛ^{T})Φᵣ and y_{p;r}=(I_{f} [symbol] Dₛ^{T})pᵣ, respectively. The dispersion of the SD vector yᵣ=[y_{φ;r}^{T},y_{p;r}^{T}]^{T} follows therefore as

D(yᵣ)=(Qᵣ)ᵣᵣQ_{f} [symbol] Qₛ with Qₛ=blockdiag[Dₛ^{T}Q_{φ}Dₛ, Dₛ^{T}QₚDₛ] (15)

This can be generalized to the case of r receivers, if y is defined as y=[y₁, . . . , yᵣ]. Then

D(vec(y))=Qᵣ [symbol] Q with Q=Q_{f} [symbol] Qₛ (16)

Let c₁=[1,0, . . . 0]^{T} and Dᵣ^{T}=[−eᵣ₋₁,Iᵣ₋₁], then [y₁, Y]=y[c₁, Dᵣ]. Therefore vec([y₁, Y])=([c₁, Dᵣ]^{T} [symbol] I_{2f(s-1)})vec(y), from which the dispersion of the combined model (c.f. 12) follows as

$$D [ \begin{matrix}{y}_{1} \\ vec ( Y )\end{matrix} ] = [ \begin{matrix}{c}_{1}^{T} {Q}_{r} {c}_{1} & {c}_{1}^{T} {Q}_{r} {D}_{r} \\ {D}_{r}^{T} {Q}_{r} {c}_{1} & {D}_{r}^{T} {Q}_{r} {D}_{r}\end{matrix} ] ⊗ Q \qquad ( 17 )$$

The nonzero correlation between y₁ and Y is due to c₁^{T}QᵣDᵣ≠0.

The nonzero correlation between y₁ and Y implies that treating the positioning problem independently from the attitude determination problem is suboptimal. An optimal solution can be obtained if the nonzero correlation is properly taken into account. This suggests that the two sets of observation equations of (12) and their corresponding parameter estimation problems can be considered in an integral manner.

Alternatively, as described below, an independent treatment with optimal results is still feasible, provided it is preceded by a decorrelation of the two data sets, combined with a proper reparameterization.

In this embodiment, the decorrelating transformation used is

$$D = [ \begin{matrix}1 & - {c}_{1}^{T} {Q}_{r} {{D}_{r} ( {D}_{r}^{T} {Q}_{r} {D}_{r} )}^{- 1} \\ 0 & {I}_{r - 1}\end{matrix} ] ⊗ {I}_{2 f ( s - 1 )} \qquad ( 18 )$$

It achieves the decorrelation by replacing y₁ with a special linear combination of y₁ and Y, denoted as y̅.

If [symbol] is applied to [y₁^{T}, vec(Y)^{T}]^{T}, the set of observation equations (12) transforms to

E(y)=(e_{2f} [symbol] G) b̅+(H [symbol] Iₛ₋₁)a+d₁

E(Y)=(e_{2f} [symbol] G)B+(H [symbol] Iₛ₋₁)Z (19)

where

y̅^{T}=(eᵣ^{T}Qᵣ⁻¹eᵣ)⁻¹eᵣ^{T}Qᵣ⁻¹[y₁, . . . , yᵣ]^{T} (20)

with a similar definition for ā and b̅. Expression (20) follows from using Y=yDᵣ and the projector identity QᵣDᵣ(Dᵣ^{T}QᵣDᵣ)^{-T}Dᵣ^{T}=Iᵣ−eᵣ(eᵣ^{T}Qᵣ⁻¹eᵣ)⁻¹eᵣ^{T}Qᵣ⁻¹ in y̅₁=y₁−[c₁^{T}QᵣDᵣ(Dᵣ^{T}QᵣDᵣ)⁻¹ [symbol] I_{2f(s-1)}]vec(Y). Note that the entries of the decorrelated observation vector y̅ are a weighted least-squares combination of the corresponding r receiver measurements. The weights are provided by the matrix Qᵣ. Thus in case this matrix is diagonal, y̅ becomes a weighted average of the original observation vectors yᵢ, i=1, . . . , r.

Note that the transformed set of observation equations (19) has the same structure as the original set (12). Hence, one can use the same software packages to solve for the parameters of (19) as has been used hitherto to solve for the parameters of (12). Importantly, however, the results will now be optimal since the correlation has rigorously been taken into account. Thus one can use current software packages that treat the position estimation problem independently from the attitude estimation problem, while at the same time obtaining an improved, optimal, position estimate.

To illustrate that the position estimate improves, it will now be shown that y̅ has a better precision than y₁. For the dispersion of [ y̅, Y]:

$$D [ \begin{matrix}\overline{y} \\ vec ( Y )\end{matrix} ] = [ \begin{matrix}{( {e}_{r}^{T} {Q}_{r}^{- 1} {e}_{r} )}^{- 1} & 0 \\ 0 & {D}_{r}^{T} {Q}_{r} {D}_{r}\end{matrix} ] ⊗ Q \qquad ( 21 )$$

Compare this result with (17). Since 1=(c₁^{T}eᵣ)²=(c₁^{T}Q_{r.}Qᵣ⁻¹eᵣ)²=(c₁^{T}Qᵣc₁)(eᵣ^{T}Qᵣ⁻¹eᵣcos²(α) and c₁≠eᵣ, the strict inequality (eᵣ^{T}Qᵣ⁻¹eᵣ)⁻¹<(c₁^{T}Qᵣc₁) exists and therefore:

D( y̅)<D(y₁) (22)

Thus the precision of y̅ is always better than that of y₁.

As an example, consider an array with r receivers that are all of the same quality. Then Qᵣ=Iᵣ and

$$D ( {\overline{y}}_{1} ) = \frac{1}{r} D ( {y}_{1} ) .$$

This ‘1 over r’ rule improvement propagates then also into the parameter estimation of y̅'s observation equations (c.f. 19). In the next section, different positioning concepts for which the above improvements apply are described.

Three different ways of applying the attitude-precise point positioning (A-PPP) model (19) will now be described. Each of these approaches is worked out in more detail in the sections following.

Variant 1:

Since y̅ and Y are uncorrelated and their observations equations in (19) have no parameters in common, the two sets of equations can be processed separately. The attitude solution will be the same as before, but the positioning solution will show an improvement. This improvement is larger, for larger r, i.e. for a larger number of receivers 14. Thus in this approach one can process the SD A-PPP observation equations (c.f. 19) just like one would process the original PPP observations (c.f. 12). The position vector determined by A-PPP (c.f. 20) is

b̅=[b₁, . . . , bᵣ]Qᵣ⁻¹eᵣ(eᵣ^{T}Qᵣ⁻¹eᵣ)⁻¹ (23)

It is a weighted least-squares combination of the r receiver positions. For instance, for a diagonal Qᵣ⁻¹=diag[w₁, . . . , wᵣ], the position vector b̅ is equal to a weighted average of the r receiver positions,

$$\overline{b} = \frac{{\sum }_{i = 1}^{r} {w}_{i} {b}_{i}}{{\sum }_{i = 1}^{r} {w}_{i}} \qquad ( 24 )$$

Thus A-PPP estimates the position of the ‘center of gravity’ of the receiver array 12 rather than that of a single receiver 14 position. If needed, these two positions can be made to coincide by using a suitable symmetry in the receiver array 12 geometry. That is, b̅=b₁ if Σᵢ₌₁^{r}wᵢb₁ᵢ=0.

Variant 2:

The second approach considers A-PPP with integer ambiguity resolution included. Although PPP integer ambiguity resolution has largely been ignored in the past due to the non-integer nature of the SD ambiguities, integer ambiguity resolution of these ambiguities becomes possible in principle, if suitable corrections for the fractional part of these SD ambiguities can be provided externally.

Various studies have shown that this is indeed possible however, applying this to A-PPP presents a problem since, with A-PPP, the ambiguity vector ā remains noninteger even after the original SD ambiguities have been corrected to integers. The weighted average of integers is namely generally noninteger. The solution to the nonintegerness of a is to make use of the relation

ā=a₁−Z(Dᵣ^{T}QᵣDᵣ)⁻¹Dᵣ^{T}Qᵣe₁ (25)

Thus if Z, the integer matrix of DD array ambiguities, is known, one can undo the effect of averaging and express ā in a₁, which itself can be corrected to an integer by means of the externally provided fractional correction. The usefulness of (25) depends on how fast and how well the integer matrix Z can be provided.

Preferably this should be on a single-epoch basis, i.e. instantaneously, with a sufficiently high success-rate.

This is indeed possible with the described method.

Variant 3:

The A-PPP concept can also be applied to the field of relative navigation (e.g. formation flying). Consider two A-PPP equipped platforms P and Q. By taking the between-platform difference of the platform's SD observation equations (c.f. 19), one obtains

E( y̅_{PQ})=(e_{2f} [symbol] G) b̅_{PQ}+(H [symbol] Iₛ₋₁)ā_{PQ} (26)

where b̅_{PQ} is the baseline vector between the two platform ‘array centres of gravity’ and [symbol] is the ambiguity vector. Since this averaged between-platform ambiguity vector can be expressed as a difference of two equations like (25), it is the difference of an integer vector (the DD ambiguity vector of the platform's master receivers) and a known linear function of two DD integer matrices. Thus, [symbol] can be corrected to an integer vector by means of the two array's DD integer matrices. Hence, importantly, the resolution of the between-platform integer ambiguity problem (c.f. 26) benefits directly from the ‘1 over r’ precision improvement of y̅_{PQ}.

This concept is easily generalized to an arbitrary number of A-PPP equipped platforms. These platforms may be in motion or they may be stationary. Due to the precision improvement, one can now also permit longer distances between the platforms, while still having high-enough success rates. In the stationary case for instance, the A-PPP concept could provide more robust ambiguity resolution performance for continuously operating reference station (CORS) networks.

The following described receiver systems in accordance with embodiments of the present invention and use of the receiver systems in further detail. For example, a platform may be equipped with a number of r GNSS antennas and a geometrical arrangement of the antennas' phase centres on the platform is assumed known in the body frame. In this example, each antenna tracks the same number of s satellites on the same f frequencies, thus producing per epoch, fs undifferenced (UD) phase observations and fs UD code observations (s≧4, f≧1). From these UD observations, a between-satellite single-differenced (SD) 2f(s−1) observation vector yᵢ can be constructed for each antenna, i=1, . . . , r. From these r observation vectors, a 2f(s−1) X (r−1) matrix of double-differenced (DD) observation vectors, Y=[y₁₂, . . . , y₁ᵣ], can be constructed for the whole array of r antennas (Note: y₁ᵢ=yᵢ−y₁).

For the SD-vector y₁ and the DD matrix Y, single epoch observation equations can be formulated:

E(y₁)=A₁b₁+A₂a₁+d₁

E(Y)=A₁B+A₂Z (27)

wherein A₁=(e_{2f} [symbol] G), A₂=(H [symbol] Iₛ₋₁), H=[Λ, 0]T, Λ=diag[λ₁, . . . , λ_{f}], b₁ is the position vector of (master) antenna 1, a₁ is the SD ambiguity vector of (master) antenna 1, d₁ comprises the atmospheric (troposphere, ionosphere) and ephemerides (orbit and clock) terms, B=[b₁₂, . . . , b₁ᵣ] the 3×(r−1) matrix of baseline vectors between antennas of array (i.e. b₁ᵢ=bᵢ−b₁), Z is the f(s−1)×(r−1) matrix of DD integer ambiguities. Note: since in this example all antennas of the array are assumed to be not further apart than 1 km, the two sets of observation equations in (27) can be assumed to have the same design matrices A₁ and A₂.

Since the antenna geometry is assumed known in the platform body frame, B may be further parameterized in the entries of a 3×q orthogonal matrix R (R^{T}R=I_{q}),

B=RF, R∈ [symbol] ^{3×q} (28)

in which the q×(r−1) matrix F contains the known body frame coordinates of the r−1 baselines ( [symbol] ^{3×q} denotes the space of 3×q orthogonal matrices; for q=3 it is a rotation matrix when the determinant is +1). With 2 baselines q=1, with 3 baselines q=2, and for more than 3 baselines q=3.

Substitution of (28) into the second equation of (27) gives:

E(Y)=A₁RF+A₂Z, R∈ [symbol] ^{3×q}, Z∈ [symbol] ^{f(s-1)×(r-1)} (29)

The unknowns in this system are R and Z. The orthogonal matrix R describes the attitude of the platform. The A-PPP attitude solution of (29) is defined as the solution of the mixed integer orthogonally constrained multivariate integer least-squares problem (this problem is referred to as the multivariate constrained integer least-squares problem, MC-ILS):

$$\begin{matrix}R \\ Z\end{matrix} \} = arg {min}_{R , Z} {‖ vec ( Y - {A}_{1} RF - {A}_{2} Z ) ‖}_{{Q}_{vec ( Y )}}^{2} \\ subject to \\ R ∈ {𝕆}^{3 \times q} , \\ Z ∈ {ℤ}^{f ( s - 1 ) \times ( r - 1 )} \qquad ( 30 )$$

The integer matrix minimizer of (30), \tilde{Z}, can be efficiently computed with the multivariate constrained LAMBDA method. The orthogonal matrix \tilde{R} describes the precise A-PPP attitude solution of the platform.

The above may be summarized in the following equation:

$$Y ⇒ MC - ILS ( 30 ) ⇒ {R}^{⋁} , {Z}^{⋁} \qquad ( 31 )$$

Variant 1:

In this variant the data of the r antennas is used to construct the weighted least-squares (WLS) observational vector:

y̅=y₁−Y(Dᵣ^{T}QᵣDᵣ)⁻¹Dᵣ^{T}Qᵣe₁ (34)

in which Qᵣ describes the relative quality of the antennas involved. The observational vector y̅ is then used to solve for the unknown parameters ā and b̅ in the model:

E( y̅)=A₁ b̅+A₂ā+d₁ (35)

Since the structure of the model is the same as that of PPP, standard PPP software/algorithms can be used to solve for the parameters. Usually a recursive least-squares or Kalman filter formulation is used. The solution will be more precise than the standard PPP solution, since D( y̅)<D(y₁).

The above may be summarized as follows:

$$\{ \begin{matrix}{y}_{1} , Y & ⇒ WLS - combination ( 34 ) ⇒ \overline{y} \\ \overline{y} & ⇒ LS \text{/} Kalman Filter Solution ( 35 ) ⇒ {a}^{\hat{\_}} , \hat{\overline{b}}\end{matrix} \qquad ( 36 )$$

Variant 2:

This variant applies if the fractional part of the SD ambiguity vector al is provided externally. It implies that the integer part of a₁ can be resolved and therefore a much more precise position solution can be obtained. In order to make this possible the WLS solution y̅ needs to be ambiguity-corrected using the DD integer matrix as computed from (30). Thus, instead of the weighted least-squares observational vector y̅, the following is used:

\tilde{y}= y̅+A₂\tilde{Z}(Dᵣ^{T}QᵣDᵣ)⁻¹Dᵣ^{T}Dᵣe₁ (37)

and the unknown parameters a₁ and b̅ are solved for in the model:

E(\tilde{y})=A₁ b̅+A₂a₁+d₁ (38)

Summarising:

$$\{ \begin{matrix}{y}_{1} , Y & ⇒ WLS - combination ( 34 ) ⇒ \overline{y} \\ Y & ⇒ MC - ILS ( 30 ) ⇒ {R}^{⋁} , {Z}^{⋁} \\ \overline{y} , {Z}^{⋁} & ⇒ Ambiguity correction ( 37 ) ⇒ \tilde{y} \\ \tilde{y} & ⇒ LS \text{/} Kalman Filter Solution ( 38 ) ⇒ {{a}^{⋁}}_{1} , {b}^{{\_}^{⋁}}\end{matrix} \qquad ( 39 )$$

Variant 3:

This variant applies if two A-PPP equipped platforms, P and Q, are provided. The between-platform difference of \tilde{y}_{P} and \tilde{y}_{Q} is now used,

\tilde{y}_{PQ}= y̅_{PQ}+\tilde{Z}_{PQ}(Dᵣ^{T}QᵣDᵣ)⁻¹Dᵣ^{T}Qᵣe₁ (40)

and the unknown parameters a_{1,PQ} and b̅_{PQ} are solved for in the model:

E(\tilde{y}_{PQ})=A₁ b̅_{PQ}+A₂a_{1,PQ} (41)

where b̅_{PQ} is the baseline vector between the two platform ‘array centres of gravity’ and a_{1,PQ} is now a DD ambiguity vector and therefore integer. This integerness is exploited through the ambiguity resolution process when solving for the parameters of (41).

Summarising:

$$\begin{matrix}{{[ {y}_{1} , Y ]}_{P} ⇒ WLS - combination ⇒ {\overline{y}}_{P} ; \\ [ {y}_{1} , Y ]}_{Q} ⇒ WLS - combination ⇒ {\overline{y}}_{Q} \\ {Y}_{P} ⇒ MC - ILS ⇒ {{Z}^{⋁}}_{P} ; \\ {Y}_{Q} ⇒ MC - ILS ⇒ {{Z}^{⋁}}_{Q} & ( 42 ) \\ {\overline{y} }_{pQ} , {{Z}^{⋁}}_{pQ} ⇒ Ambiguity correction ( 40 ) ⇒ {\tilde{y}}_{PQ} \\ {\tilde{y}}_{PQ} ⇒ LS \text{/} Kalman Filter Solution ( 41 ) ⇒ {{\overline{a}}^{⋁}}_{1 , PQ} , {{\overline{b}}^{⋁}}_{PQ} & ( 43 )\end{matrix}$$

Computer Implementation

Throughout these embodiments, the position and attitude estimates and associated calculations may be conducted using a computer loaded with appropriate software, e.g. PCs running software that provides a user interface operable using standard computer input and output components. Such software may be in the form of a tangible computer readable medium containing computer readable program code. When executed, the tangible computer readable medium would carry out at least some of the steps of method 20. Such a tangible computer readable medium may be in the form of a CD, DVD, floppy disk, flash drive or any other appropriate medium.

In one embodiment, the software is arranged when executed by the computer to calculate a position estimate and an attitude estimate associated with the plurality of receivers using a received navigational signal. In this embodiment, the software uses information associated with the positions of the receivers relative to each other when calculating the attitude estimate.

The software then determines a relationship between the position estimate and the attitude estimate of the plurality of receivers as a function of a change of the received navigational signal, such as by determining a correlation between the estimates. The relationship between the estimates is then used by the software to calculate an improved position estimate by using the determined relationship between the position estimate and the attitude estimate of the.

FIG. 3 shows in more detail the calculation system 18 for obtaining positional information using navigational signals received by a plurality of receivers. The calculation system 18 comprises a series of modules that could, for example, be implemented by a computer system having a processor executing the computer readable program code described above to implement a number of modules 46, 48, 50.

In this example, the calculation system 18 has input 42 and output 44 components, such as standard computer input devices and an output display, to allow a user to interact with the calculation system 18. The input components 42 can also be arranged to receive the navigational signals received by the plurality of receivers. The calculation system 18 further comprises a position and attitude estimation module 46 in communication with the input components 42 and is arranged to calculate a position estimate and an attitude estimate associated with the receivers based on the received navigational signals.

The position and attitude estimation module 46 is in communication with a relationship determiner 48 arranged to receive position and attitude estimate information from the position and attitude estimation module and to determine a relationship between the position estimate and the attitude estimate.

The relationship determiner 48 is in communication with an improved position estimation module 50 arranged to receive relationship information from the relationship determiner 48 and to calculate an improved position estimate by using the relationship information.

The resulting improved position estimate calculated by the improved position estimation module 50, and the attitude estimate calculated by the position and attitude estimation module 46, are then communicated to the output component 44. This information can then be used by the user.

Numerous variations and modifications will suggest themselves to persons skilled in the relevant art, in addition to those already described, without departing from the basic inventive concepts. All such variations and modifications are to be considered within the scope of the present invention, the nature of which is to be determined from the foregoing description.

For example, it will be appreciated that the method could be applied to any appropriate location system, or to any GNSS including GPS and future GNSSs. Further, these systems could be used alone or in combination.

Further, it will be appreciated that the method can be used to determine atmospheric and/or ephemeris information. For example, if positional information is provided, equation (27) can be solved for d₁ so as to provide atmospheric and ephemeris data.

Details concerning array-aided precise point positioning are also disclosed in “A-PPP: Array-aided Precise Point Positioning with Global Navigation Satellites Systems”, Teunissen, P. J. G., IEEE Transactions on Signal Processing Volume: 60 Pages: 1-12 Number: 6 Year: 2012. This publication is herewith incorporated in its entirety by cross-reference.

It is to be understood that, if any prior art publication is referred to herein, such reference does not constitute an admission that the publication forms a part of the common general knowledge in the art, in Australia or any other country.

1. A method of estimating a quantity associated with a receiver system, the receiver system comprising a plurality of spaced apart receivers that are arranged to receive a signal from a satellite system, the method comprising the steps of:
receiving the signal from the satellite system by receivers of the receiver system;
calculating a position estimate associated with at least one of the receivers and an attitude estimate associated with at least two receivers;
determining a relationship between the calculated position estimate and the calculated attitude estimate; and
estimating the quantity associated with the receiver system using the determined relationship between the calculated position estimate and the calculated attitude estimate.

2. The method of claim 1, wherein the quantity associated with the receiver system is a position estimate.

3. The method of claim 1, wherein the quantity associated with the receiver system is an attitude estimate.

4. The method of claim 1, wherein the quantity associated with the receiver system is atmospheric and/or ephemeris information.

5. The method of claim 1, wherein the steps of calculating a position estimate and an attitude estimate, determining a relationship between the calculated position estimate and the calculated attitude estimate of the receiver system, and estimating the quantity associated with the receiver system are performed immediately after receiving the signal from the satellite system such that the quantity associated with the receiver system is estimated substantially instantaneously.

6. The method of claim 1, wherein the receivers of the receiver system have a known spatial relationship relative to each other and the step of estimating the quantity associated with the receiver system comprises using known information associated with the known spatial relationships.

7. The method of claim 1, wherein the receivers are arranged in a substantially symmetrical manner.

8. The method of claim 1, wherein the receivers form an array.

9. The method of claim 1, wherein the step of determining the relationship between the position estimate and the attitude estimate comprises determining a dispersion of the position estimate and the attitude estimate.

10. The method of claim 9, wherein the step of estimating the quantity associated with the receiver system comprises processing the position estimate and attitude estimate using information associated with the determined dispersion.

11. The method of claim 10, wherein processing the position and attitude estimates comprises applying a decorrelation transformation and using information associated with the determined dispersion.

12. The method of claim 1, wherein the plurality of spaced apart receivers comprises a first and a second group of receivers, the method comprising the steps of:
calculating a position and an attitude estimate for receivers of the first group and receivers of the second group;
determining a relationship between at least one estimates for the first group of receivers with at least one estimates for the second group of receivers; and
using the determined relationship for estimating the quantity associated with the receiver system.

13. The method of claim 1, wherein the signal is a single frequency signal.

14. The method of claim 1, wherein the signal is a multiple frequency signal.

15. The method of claim 1, comprising selecting positions of the receivers relative to each other in a manner such that the an accuracy of the estimate of the quantity of the property associated with the receiver system is improved compared with an estimate obtained for different relative receiver positions.

16. A tangible computer readable medium containing computer readable program code for estimating a quantity associated with a receiver system comprising a plurality of spaced apart receivers, the receivers being arranged to receive a signal from a satellite system, the tangible computer readable medium being arranged, when executed, to:
calculate a position estimate and an attitude estimate associated with the receiver system using a received signal;
determine a relationship between the calculated position estimate and the calculated attitude estimate of the receiver system; and
estimate the quantity associated with the receiver system using the determined relationship between the position estimate and the attitude estimate.
